(19) United States
(12) Patent Application Publication
(10) Pub. No.: US 2006/0012070 A1
(43) Pub. Date: Jan. 19, 2006

(54) Gasket assembly

(75) Inventors: Ronald J. Fontecchio, Nashville, TN (US); Leslie J. Varga, Cumming, GA (US)

Correspondence Address: WOOD, HERRON & EVANS, LLP (NORDSON), 2700 CAREW TOWER, 441 VINE STREET, CINCINNATI, OH, 45202, US

(73) Assignee: Nordson Corporation

(21) Appl. No.: 10/889,875

(22) Filed: Jul. 13, 2004

(51) Int. Cl. B05D 5/00; B32B 1/00

(52) U.S. Cl. 264/171.13; 427/402; 427/243

(57) ABSTRACT

A gasket assembly is formed from foam-in-place gasket material disposed on a substrate. A layer of thermoplastic material is disposed on a surface of the foam gasket material such that areas of the surface remain exposed. The layer of thermoplastic material does not completely encapsulate the foam gasket material and is selected to have a friction coefficient that is less than that of the foam material. In one embodiment, the gasket assembly further includes a second layer of thermoplastic material disposed between the substrate and the foam material to help bond the foam material to the substrate. The second layer of thermoplastic material may be applied to the substrate in the form of a continuous web, or in fiberized form.

### FIELD OF THE INVENTION

The present invention pertains generally to gaskets for sealing, and more particularly to a foam-in-place gasket having reduced friction characteristics.

### BACKGROUND OF THE INVENTION

Foam-in-place gaskets find many applications in sealing between abutting components. In certain applications, foam-in-place gaskets are used in dynamic environments to seal between relatively movable abutting components. For example, foam-in-place gaskets are often used to seal between adjacent panel sections of overhead garage doors. As the garage doors are raised and lowered, the gasket is exposed to compressive forces and shear forces as the individual panel sections pivot about hinges which connect their adjacent upper and lower laterally extending edges.

Foam-in-place gaskets function best in compression. Their performance is degraded when exposed to lateral shearing forces. Exasperating this problem is the fact that foam-in-place gasket materials typically exhibit high coefficients of friction, and therefore, shear forces are increased due to the materials' tendency to resist sliding movement between the surfaces they seal against. Accordingly, the gaskets used in garage doors, and in other applications where they are exposed to lateral or shearing forces, can fail after a relatively short service life, requiring time and expense to replace the gaskets. A need therefore exists for an improved foam-in-place gasket which can be used to seal between abutting components in dynamic environments.

### SUMMARY OF THE INVENTION

The present invention provides a gasket assembly formed from foam material and is suited for use in dynamic environments where the gasket assembly will be exposed to lateral shearing forces. The gasket assembly comprises a layer of foam material disposed in a desired arrangement on a substrate, such as the edge of a garage door panel. The foam material may be applied as an elongate bead, or in any desired pattern. In one embodiment, the upper surface of the foam gasket material is covered with a layer of thermoplastic material such that areas of the surface remain exposed. The thermoplastic material may be applied to the foam material in a fiberized pattern, i.e., in a manner that is controlled and non-random. Suitable illustrative patterns are oscillating, looped or swirl patterns.

The fiberized form of the layer of thermoplastic material is such that the foam material is not completely encapsulated by the thermoplastic material. Accordingly, foam material applied to the substrate in a foam-in-place process may continue to cure after the layer of thermoplastic material has been applied. In one embodiment, the thermoplastic material is selected to have a coefficient of friction that is less than that of the foam gasket material, so that the gasket assembly is less susceptible to being torn, or otherwise damaged, as a result of shearing forces exerted on the gasket assembly by sealed components.

In another embodiment, thermoplastic material is applied as spaced, parallel beads that extend either parallel or transverse to a longitudinal extent of the foam material. In yet another embodiment, the thermoplastic material is applied on top of the foam material in a repeating omega-shaped pattern, or as spaced-apart dots or drops.

In another embodiment, the gasket assembly further includes a second layer of thermoplastic material disposed between the substrate and the foam gasket material. The second layer of thermoplastic material helps to bond the foam material to the substrate and may be applied as a uniform web, or in a fiberized arrangement as discussed above with respect to the first layer of thermoplastic material. The thermoplastic material for the first and second layers is preferably the same material.

In another aspect of the invention, a method for making a gasket includes dispensing a first layer of thermoplastic material to a substrate, forming a layer of foam material on the first layer of thermoplastic material, and dispensing an second layer of thermoplastic material on the foam material. The first layer may be applied as a uniform coating, or in fiberized form. The second layer is applied on top the foam material such that areas of the surface of the foam material remain exposed.

In another aspect of the invention, a system for making gaskets includes a first liquid material dispensing gun, a foam dispenser downstream of the first liquid material dispensing gun, and a second liquid dispensing gun downstream of the foam dispenser. In one embodiment, the system further includes a conveyor for moving a substrate past the first liquid material dispensing gun, the foam dispenser, and the second liquid material dispensing gun, respectively, whereby a gasket assembly according to the invention, as described above, may be formed.

In yet another embodiment, a plurality of longitudinally extending beads of thermoplastic material are formed simultaneously with the foam material in a coextrusion process.

The features and objectives of the present invention will become more readily apparent from the following Detailed Description taken in conjunction with the accompanying drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a perspective view of a foam-in-place gasket assembly according to the present invention;

FIG. 2 is a cross-section of the foam-in-place gasket assembly of FIG. 1;

FIG. 2A is a cross-sectional view of another embodiment of a foam-in-place gasket assembly according to the present invention;

FIGS. 3A-3D are a perspective views of other embodiments of foam-in-place gasket assemblies according to the present invention;

FIG. 4 is a perspective view of still another embodiment of a foam-in-place gasket assembly according to the present invention;

FIG. 5 is a schematic illustration of a system for making foam-in-place gasket assemblies according to the present invention; and

FIG. 6 is a cross-sectional view of another embodiment of a foam-in-place gasket assembly according to the present invention.

### DETAILED DESCRIPTION

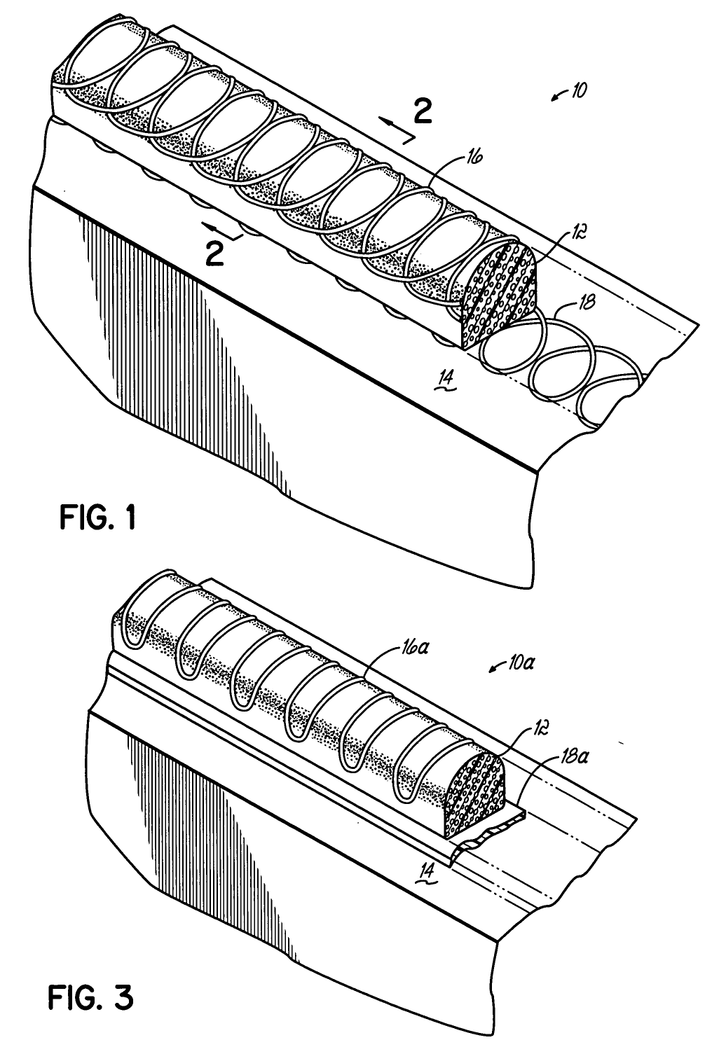

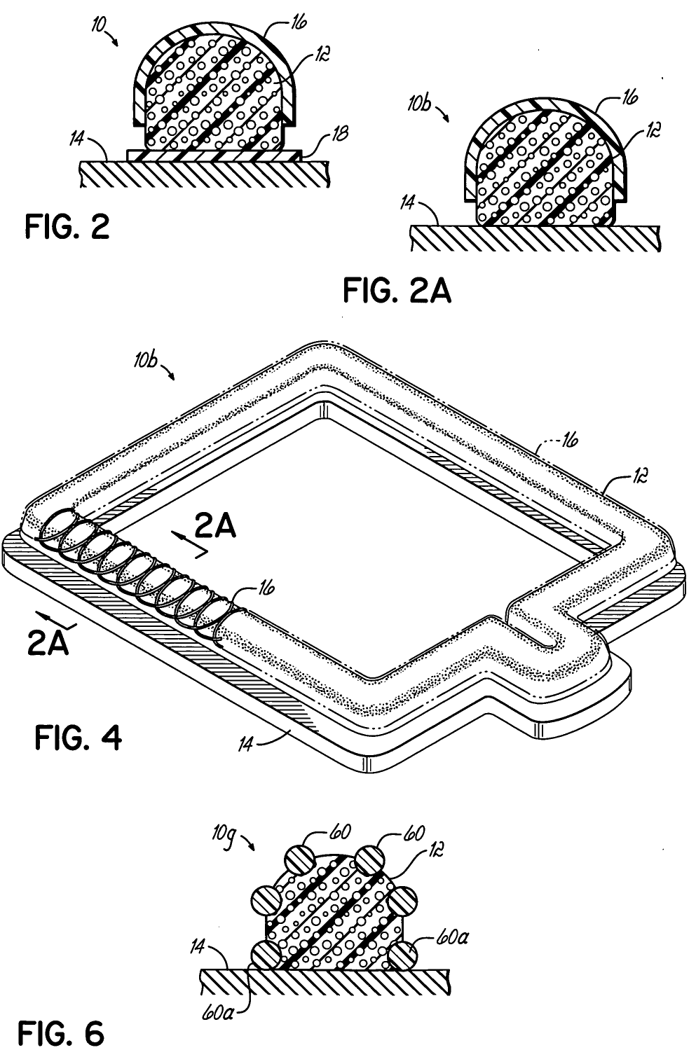

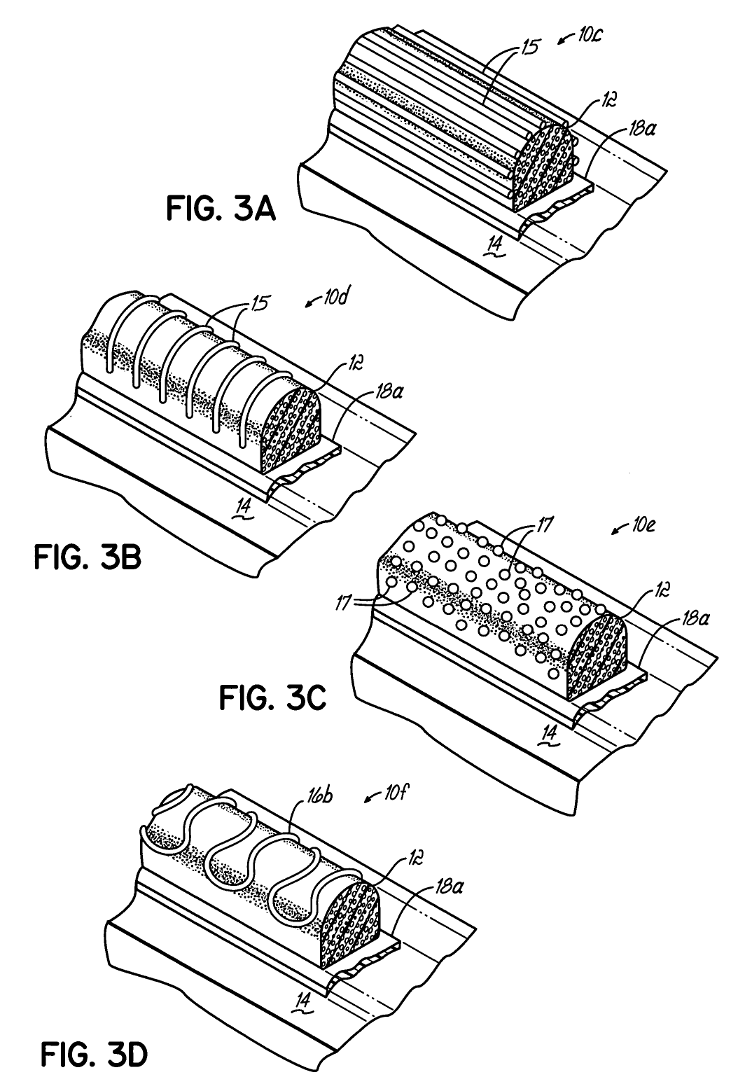

Referring to FIGS. 1 and 2, a gasket assembly 10, illustrative of the invention, includes a layer of foam gasket material 12 disposed on a substrate 14, such as the top edge surface of a panel used in a sectional overhead garage door. Advantageously, the gasket 12 may be applied as a bead of foam-in-place material along the substrate 14. After application to the substrate 14, the material expands to create the foam gasket 12, as known in the art. The gasket assembly 10 further includes a layer 16 of protective material disposed on top of the foam material 12. The layer 16 comprises a filament of thermoplastic material disposed atop the foam material in a fiberized pattern. The fiberized pattern may be a repeating pattern, such as for example, a looped or swirling pattern (FIG. 1) or an oscillating pattern (layer 16a of FIG. 3).

The fiberized pattern of layer 16 does not completely encapsulate the exposed surfaces of the foam material 12. Because foam-in-place materials typically cure by absorbing moisture from the environment, the unencapsulated configuration of layer 16 permits the foam-in-place bead to fully cure even after application of layer 16 of thermoplastic material. Advantageously, the material of layer 16 is selected to have a friction coefficient which is less than the friction coefficient of the foam-in-place gasket material 12. Accordingly, when the gasket assembly 10 is used in applications where the gasket assembly 10 is exposed to shear forces, the reduced friction coefficient facilitates sliding movement between the adjacent components that are sealed by the foam material 12. Moreover, the repeating pattern of layer 16 provides a relatively uniform dispersion of thermoplastic material on the bead of foam material 12, without creating areas having excessive build-up or agglomeration, as would otherwise tend to occur if layer 16 were applied in a random fashion.

The gasket assembly 10 may further include layer 18 of thermoplastic material disposed between the substrate 14 and the foam material 12. Layer 18 of thermoplastic material securely bonds the foam material 12 to the substrate 14 so that the gasket assembly 10 will not readily tear away from the substrate 14 when exposed to lateral shearing forces, such as those experienced by adjacent garage door panels when the door is opened and closed. Layer 18 may be disposed on the substrate 14 in any pattern or arrangement which provides a secure bond between the foam material and the substrate. For example, layer 18 may be applied in a repeating pattern such as an oscillating, looped, or swirl pattern (FIG. 1) or it may be applied in a random fiberized manner, or as a continuous uniform coating of material 18a (FIG. 3).

Alternatively, when the foam material 12 and the substrate material are selected such that the foam-in-place gasket will readily form a bond with the material of the substrate 14, the foam-in-place gasket material 12 may be applied directly to the surface of the substrate 14 (FIGS. 2A and 4) without the need for layer 18 of thermoplastic material.

Advantageously, the layer 18 of thermoplastic material may be selected to be the same material used for the layer 16. The thermoplastic material for the layers 16, 18 may be a reactive polyurethane, ethylene vinyl acetate (EVA), polyolefin, polyamides, or other materials suitable for adhering to foam material and providing a reduced friction coefficient.

FIGS. 3A-3D depict additional embodiments of gasket assemblies 10c, 10d, 10e, 10f according to the present invention. In FIGS. 3A and 3B, a layer of thermoplastic material is applied to the top of the foam material 12 in the form of spaced parallel beads 15. The beads 15 may extend in a direction substantially parallel to a longitudinal extent of the foam material 12, FIG. 3A, or may extend in directions substantially transverse to the longitudinal extent of the foam material 12, FIG. 3B. In yet another embodiment of a gasket assembly 10e according to the present invention, thermoplastic material may be applied to the top of the foam material 12 as a plurality of spaced drops or dots 17, FIG. 3C. In FIG. 3D, a gasket assembly 10f according to the present includes a layer of thermoplastic material 16b applied to the top of the foam material 12 in a pattern resembling a series of repeating omega shapes.

While FIGS. 1 and 3 depict a gasket assembly 10 according to the present invention in the form of an elongate bead of foam material, it will be recognized that the gasket assembly may have other configurations as well. For example, and with reference to FIG. 4, there is shown another embodiment of a foam gasket assembly 10b, according to the present invention, in the form of a “closed” gasket, i.e., the gasket forms a closed loop. In the embodiment shown, the gasket assembly 10b has a generally rectangular configuration, but it will be recognized that the gasket may be formed in other configurations as well. In this embodiment, the substrate 14 comprises material formed in the desired gasket shape. The foam-in-place gasket 12 may be applied directly to the substrate 14, or a layer of thermoplastic material (not shown) may first be applied to the substrate 14 to bond the foam-in-place material 12 to the substrate, as described above. After the foam-in-place material has expanded to the desired gasket profile, and has cured sufficiently to support the weight of the upper layer, layer 16 of thermoplastic material is applied on top of the foam material 12, as described above.

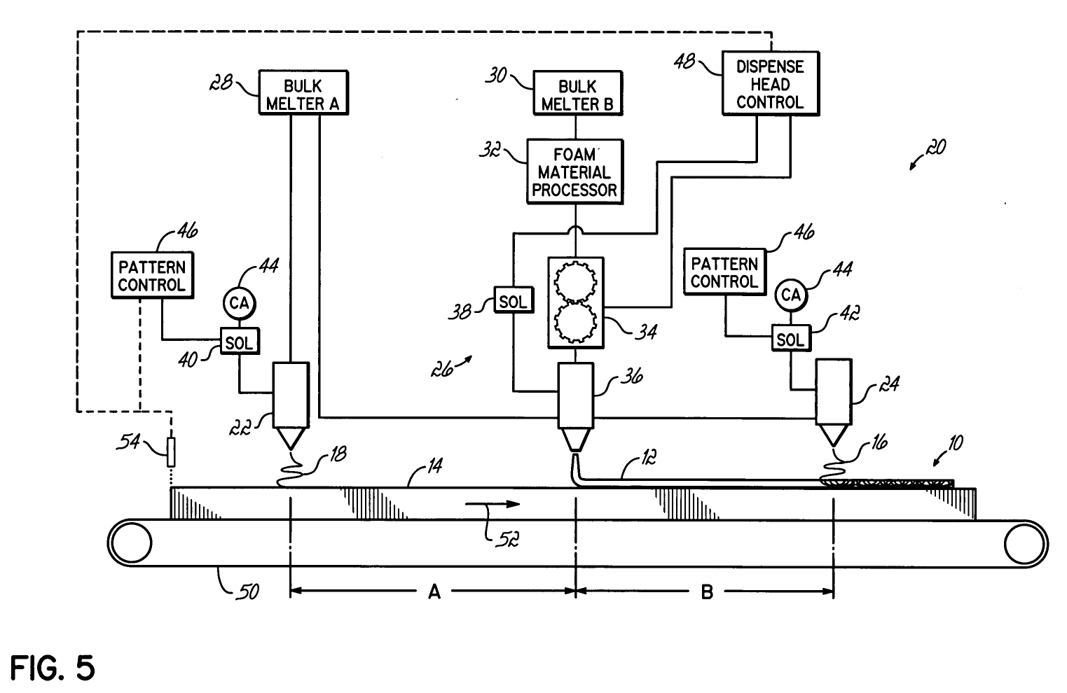

Referring now to FIG. 5, there is shown a system 20 for manufacturing a gasket assembly 10, as described above. The system 20 includes first and second liquid material dispensing guns 22, 24 and a foam dispensing head 26 arranged proximate a conveyor 50 such that the first liquid dispensing gun 22 is positioned upstream of the foam dispensing head 26, and the foam dispensing head 26 is upstream of the second liquid dispensing gun 24. Exemplary liquid dispensing guns which could be used with the invention are the CF Series Controlled Fiberation™ guns available from Nordson Corporation of Westlake, Ohio. An exemplary foam dispensing head is the pro-meter VDK metering system, with an A6900 gun module, also available from Nordson Corporation. Each of the liquid material dispensing guns 22, 24 is provided with liquid material, such as hot melt adhesive, from a bulk melter 28 which receives thermoplastic material in solid form and melts it to a temperature suitable for dispensing from the guns 22, 24.

Gasket material in solid form is provided to a second bulk melter 30 where it is heated and melted prior to being supplied to a foam material processor 32 which aerates the liquid gasket material. An exemplary bulkmeter is the BM200 series bulkmeter, and an exemplary foam material processor is the FoamMix® dispensing system, both available from Nordson Corporation. The aerated gasket material is then provided to the foam dispensing head 26 which includes a gear pump 34, a nozzle 36 configured to dispense the gasket material 12 as an elongate bead, and a solenoid 38 for operating the nozzle 36 between open and closed positions to thereby dispense the foam-in-place material to a substrate 14.

The first and second liquid dispensing guns 22, 24 are operated by respective solenoid valves 40, 42 for actuation between open and closed positions and are coupled to a source of compressed air 44 for attenuating and controlling the pattern of liquid material dispensed therefrom, as known in the art. The solenoids 40, 42 of the first and second liquid dispensing guns 22, 24 may be controlled by a first, liquid pattern controller 46. A second dispense head controller 48 may control the operation of the gear pump 34 and solenoid 38 of the foam dispensing head 26.

A substrate 14, such as a garage door panel section, is supported on the conveyer 50 for movement along a machine direction 52 beneath the first liquid material dispensing gun 22, the foam material dispense head 26, and the second liquid material dispensing gun 24, respectively. A sensor 54 positioned adjacent the conveyor detects the presence of the substrate 14 moving along the conveyer 50 and sends a signal to the pattern control 46 and dispense head control 48 to initiate dispensing layers 16, 18 of thermoplastic material and the foam material layer 12 to create the gasket assembly 10 as described above. Specifically, as the substrate 14 is moved in the machine direction 52 along the conveyer 50, the first liquid material dispensing gun 22 applies a layer 18 of thermoplastic material to the substrate 14. Layer 18 may be in the form of a continuous web, a random fiberized arrangement, a repeating pattern, or in other suitable forms.

As the substrate 14 continues along the conveyer 50, the foam material dispense head 26 applies an elongate bead of foam material 12 to the substrate 14, atop layer 18 of thermoplastic material. The substrate 14 continues along the conveyer 50 while the bead of foam material 12 expands to the desired gasket shape. After the foam material 12 has fully expanded and has sufficiently cured to support upper layer 16, the second liquid material gun 24 dispenses layer 16 of thermoplastic material atop the foam material 12.

Advantageously, the spacing A between the first liquid material dispensing gun 22 and the foam material dispense head 26, is selected such that the foam material 12 is applied atop layer 18 of thermoplastic material during a time when the lower layer 18 may bond the foam material 12 to the substrate 14. The spacing B between the foam material dispense head 26 and the second liquid material dispensing gun 24 is selected to correspond to the speed of the substrate 14 along the conveyor 50 such that the foam material 12 has sufficient time to fully expand to the desired gasket profile and to cure sufficiently to support the weight of layer 16 of thermoplastic material on top of the foam material 12. Advantageously, selective adjustment of the spacing A and spacing B may be automatically controlled by the system 20 to accommodate changes in the speed of the conveyor 50. This may be accomplished by, for example, mounting guns 22, 24 to movable supports or to robot arms that are cooperatively controlled to move to the correct positions to accommodate changes in the speed of the conveyor 50.

Referring now to FIG. 6, there is shown yet another embodiment of a gasket assembly 10f according to the present invention. In this embodiment, a plurality of longitudinally extending beads 60 of thermoplastic material are formed concurrently with the foam material 12 in a coextrusion process. The beads 60 of thermoplastic material are spaced around the entire periphery of the foam material 12. When the coextruded foam material and thermoplastic beads are deposited on a substrate 14, the beads 60a that are sandwiched between the substrate 14 and the foam material 12 help bond the foam material 12 to the substrate 14.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of Applicant's general inventive concept.

1. A gasket assembly, comprising:
a substrate;
a layer of foam material disposed on said substrate, said layer of foam material having a surface; and
a first layer of thermoplastic material disposed on said surface of said foam material such that areas of said surface remain exposed.

2. The gasket assembly of claim 1, further comprising:
a second layer of thermoplastic material disposed between said substrate and said foam material.

3. The gasket of claim 1, wherein said foam material is in the form of an elongate bead.

4. The gasket assembly of claim 1, wherein said first layer of thermoplastic material is disposed on said surface in a fiberized pattern.

5. The gasket of claim 4, wherein said fiberized pattern of said first layer comprises one of the following:
a) a swirl pattern;
b) an omega-shaped pattern; and
c) a plurality of parallel beads of thermoplastic material.

6. The gasket of claim 2, wherein said second layer comprises one of the following:
a) a uniform coating of thermoplastic material; and
b) a filament of thermoplastic material disposed in a fiberized form.

7. (canceled)

8. The gasket of claim 6, wherein said fiberized form of said second layer comprises a swirl pattern.

9. The gasket of claim 4, wherein said fiberized pattern of said first layer comprises a plurality of bead sections extending substantially transverse to a longitudinal direction of said foam material layer.

10. The gasket of claim 9, wherein said transverse bead sections are defined by substantially sinusoidal filaments of thermoplastic material.

11-12. (canceled)

13. The gasket of claim 5, wherein said fiberized pattern comprises a plurality of parallel beads and wherein said parallel beads extend substantially longitudinally along said foam material layer.

14. The gasket of claim 5, wherein said fiberized pattern comprises a plurality of parallel beads and wherein said parallel beads extend substantially transverse to said foam material layer.

15. The gasket of claim 1, wherein said first layer is selected to have a coefficient of friction that is less than the coefficient of friction of said foam material.

16. The gasket of claim 1, wherein said first layer comprises a plurality of drops of thermoplastic material.

17. A method of making a gasket, comprising:
dispensing a first layer of thermoplastic material to a surface;
forming a layer of foam material on the first layer;
dispensing a second layer of thermoplastic material on the foam material such that areas of a surface of the foam material remain exposed.

18. The method of claim 17, wherein dispensing the second layer comprises dispensing a hot melt adhesive in a swirl pattern on the foam material.

19. The method of claim 17, wherein dispensing the first layer comprises dispensing liquid thermoplastic material as a uniform coating.

20. The method of claim 17, wherein dispensing the first layer comprises dispensing liquid thermoplastic material in fiberized form.

21. The method of claim 17, wherein the surface to which the first layer of thermoplastic material is dispensed is a moving substrate for receiving the gasket, and wherein the foam material is formed on the first layer at a time sufficient to allow the first layer to bond the foam material to the substrate, and wherein the second layer is dispensed on the foam material after the foam material has cured sufficiently to support the second layer without substantial distortion.

22. The method of claim 21, wherein the first and second layers are dispensed from respective first and second dispensers, the method further comprising:
automatically positioning the first dispenser based on the speed of the substrate such that the foam material is formed on the first layer at a time sufficient to allow the first layer to bond the foam material to the substrate; and
automatically positioning the second dispenser based on the speed of the substrate such that the second layer is dispensed on the foam material after the foam material has cured sufficiently to support the second layer without substantial distortion.

23. A method of making a gasket, comprising:
extruding a first material as a foam bead;
coextruding a plurality of beads of a second material with the first material and spaced around a periphery of the first material; and
applying the coextruded first and second materials to a substrate.

24. The method of claim 23, wherein the second material is a thermoplastic material.

25. An apparatus for making gaskets, comprising:
a first hot melt adhesive dispenser operative to dispense a first layer of hot melt adhesive to a moving substrate;
a foam dispenser downstream of said first hot melt adhesive dispenser and operative to apply a foam layer atop the first layer, said foam dispenser located downstream from said first hot melt adhesive dispenser a distance related to the speed of the substrate such that the foam layer is applied atop the first layer at a time when the first layer can bond the foam material to the substrate; and
a second hot melt adhesive dispenser downstream of said foam dispenser and operative to dispense a second layer of hot melt adhesive atop the foam layer, said second hot melt adhesive dispenser located downstream from said foam dispenser a distance related to the speed of the substrate such that the second layer is dispensed atop the foam material after the foam material has cured sufficiently to support the second layer without substantial distortion.

26. The gasket assembly of claim 1, wherein the substrate is a garage door.

27. An apparatus for making a gasket, comprising:
a means for forming a layer of foam material;
a first dispensing means for dispensing a first layer of thermoplastic material on the foam material such that areas of a surface of the foam material remain exposed.

28. The apparatus of claim 27, further comprising a means for dispensing a second layer of thermoplastic material onto a surface; and wherein the means for forming a layer of said foam material forms the layer on the second layer of the thermoplastic material.

29. The apparatus of claim 27, wherein the means for dispensing the first layer dispenses the thermoplastic material as one of the following:
a) a swirl pattern of hot melt adhesive on the foam material;
b) beads of hot melt adhesive; and
c) dots or droplets of hot melt adhesive.

30. The method of claim 17, wherein the surface to which the first layer of thermoplastic material is dispensed is a garage door.

31. The method of claim 21, wherein the surface to which the first layer of thermoplastic material is dispensed is a garage door.
